(19) United States
(12) Patent Application Publication
(10) Pub. No.: US 2005/0277102 A1
(43) Pub. Date: Dec. 15, 2005

(54) Methods and systems for interactive learning and other information exchanges, such as for use in a mobile learning environment

(76) Inventors: Charles Gillette, Sammamish, WA (US); William K. Strelke, Sammamish, WA (US); Warner Scheyer, Seattle, WA (US)

Correspondence Address: PERKINS COIE LLP;PATENT-SEA, P.O. BOX 1247, SEATTLE, WA, 98111-1247, US

(21) Appl. No.: 10/782,514

(22) Filed: Feb. 18, 2004

Related U.S. Application Data
(60) Provisional application No. 60/448,552, filed on Feb. 19, 2003.

(51) Int. Cl. G09B 3/00

(52) U.S. Cl. 434/350; 434/362

(57) ABSTRACT

Computer-implemented methods and systems for exchanging various types of information are disclosed including, e.g., instructional information for interactive or mobile learning, information relating to performance or status for monitoring or analyzing various systems, and other types of information. Computer-implemented methods and systems disclosed herein enable mobile learning by receiving at a student's computing device information from an instructional computing device relating to an educational component, presenting the received information, presenting assessments, collecting responses to the assessments, and sending the responses to the instructional computing device.

### CROSS-REFERENCE TO RELATED APPLICATION

This application claims the benefit of U.S. Provisional Application No. 60/448,552 filed on Feb. 19, 2003, which is incorporated herein in its entirety.

### BACKGROUND

Corporations that sell and support complex machinery, sensitive instrumentation or, for that matter, any other goods and services, commonly bring customers and operators into classroom settings for training. Traditional classroom teaching methods, manual evaluation of student exercises, and revisions to course curriculum long after the event have become standards for such corporate classroom learning. These methods have proven to be laborious, ineffective, and behind the times. While these methods remain important, they are expensive and time-consuming for both suppliers and customers. Shortening the duration of training while making the training more effective may have certain advantages.

The Internet has been used for some training. In brief, the Internet comprises a vast number of computers and computer networks interconnected through communication channels. Many standards have been established for exchanging information over the Internet, such as electronic mail, Gopher, and the Web. The Web service allows a server computer system (i.e., web server or web site) to send graphical web pages of information to a remote client computer system. The remote client computer system can then display the web pages. Each resource (e.g., computer or web page) of the Web is uniquely identifiable by a Uniform Resource Locator (“URL”). To view a specific web page, a client computer system specifies the URL for that web page in a request (e.g., a HyperText Transfer Protocol (“HTTP”) request). The request is forwarded to a web server that provides the web page. When that web server receives the request, it sends the requested web page to the client computer system. When the client computer system receives that web page, it typically displays the web page using a browser. A browser is typically a special-purpose application program for requesting and displaying web pages.

Currently, web pages are often defined using HyperText Markup Language (“HTML”). HTML provides a standard set of tags that define how a web page is to be displayed. When a user makes a request to a browser to display a web page, the browser sends the request to the relevant server computer system to transfer to the client computer system an HTML document that defines the web page. When the requested HTML document is received by the client computer system, the browser displays the web page as defined by the HTML document. The HTML document contains various tags that control the display of text, graphics, controls, and other features. The HTML document may contain URLs of other web pages available on that server computer system or on other server computer systems. New protocols exist, such as Extensible Mark-up Language (“XML”) and Wireless Access Protocol (“WAP”). XML provides greater flexibility over HTML. WAP provides, among other things, the ability to view web pages on handheld devices, such as cell phones and portable computers (e.g., portable digital assistants).

### BRIEF DESCRIPTION OF THE DRAWINGS

FIG. 1 is a block diagram of a suitable computer for employing aspects of the invention.

FIG. 2A is a block diagram illustrating a suitable system in which aspects of the invention may operate in a networked computer environment.

FIG. 2B is a block diagram illustrating an alternative system to that of FIG. 2A.

FIG. 3 is a block diagram illustrating a suitable system in which aspects of the invention may operate in a networked computer environment using mobile computers.

FIG. 4 is a flow diagram illustrating an example of a routine for modifying course content in response to an assessment.

FIG. 5 is a flow diagram illustrating an example of a routine for storing indications from a user relating to content of a course.

FIG. 6 is a flow diagram illustrating an example of a routine for sending course content to a student's computer.

FIG. 7 is a flow diagram illustrating an example of a routine performed by a student's computer in a classroom setting.

FIG. 8 is a block diagram illustrating an example of an object framework for delivering course content to a student.

FIG. 9 is a block diagram illustrating an example of an administrative interface for the system.

FIG. 10 is a block diagram illustrating an example of a database schema for use with the system.

Note: The headings provided herein are for convenience and do not necessarily affect the scope or interpretation of the invention.

### DETAILED DESCRIPTION

The following disclosure relates generally to computer-implemented methods and systems for exchanging various types of information, such as instructional information for interactive learning, information relating to performance or status for monitoring or analyzing various systems, and other types of information. For example, in an embodiment, the methods and systems disclosed herein can utilize one or more mobile computer devices, such as a handheld computer, a portable digital assistant (“PDA”), or an Internet-ready cellular telephone (“smart phone”), to integrate various aspects of traditional classroom and on-line learning to techniques expedite and enhance the learning experience.

As an example, the methods and systems disclosed herein may utilize an Internet-ready wireless PDA or smart phone to enhance the educational experience of students and instructors before, during, and after classroom sessions. As further examples, in various embodiments, the methods and systems disclosed herein can:
enable students and other persons in a classroom, laboratory, or home setting to access Internet-based training via a computer-network implemented device, such as a PDA, smart phone, or laptop computer, with a network connection, such as a wireless local area network (“LAN”);
enable students and other persons to perform basic training activities, such as such as accessing web-based instrument troubleshooting;
enable students and other persons to take knowledge assessment quizzes online;
enable students and other persons to review selected training content at will;
enable students and other persons to personalize their online home-training curriculum by selecting topics to review, and loading the topics into their personal profile;
enable classroom instructors and other persons to review student test scores in real time;
enable classroom instructors and other persons to identify student knowledge gaps immediately;
enable classroom instructors and other persons to create training on-the-fly; and
provide various other benefits.

In various embodiments, methods and systems disclosed herein can include interactive handheld computers that blend wireless LAN technology and e-learning with various multimedia enhancements, including, e.g., streaming video and audio. Other embodiments of the methods and systems disclosed herein utilize hardware and software applications to support and link pre-classroom training, classroom activities, student progress, classroom instructors, and post-classroom training with a single back-end application. Accordingly, implementation of these embodiments may effectively reduce the duration of corporate classroom training required by students and increase classroom productivity by providing the instructor immediate access to training management tools.

Methods and systems disclosed herein may enable students to perform various learning-related activities prior to (or instead of) attending a classroom session. As examples, students may, e.g., take a pre-class assessment, review materials to fill knowledge gaps that are required as a baseline understanding for the class, and view a course outline. Under these embodiments, an instructor may be able to review students' pre-class activities including, e.g., review assessment results, determine whether a student possesses a baseline understanding, update materials in advance of a class, send additional training or assessment materials, and view student progress.

Methods and systems disclosed herein may enable students to access their Internet-based training via a smart phone or PDA and wireless LAN in the classroom. Students can perform basic training activities including, e.g., accessing web-based instrument trouble shooting, taking knowledge assessment quizzes, and reviewing selected training content at will. Additionally, with the methods and systems disclosed, students can personalize their online home-training curriculum by selecting topics to review and loading the topics into their personal profile. When the student returns to their “home” Internet connection, they can log into their self-customized personal training curriculum.

In addition, while in the classroom, an instructor can review student test scores in real time via access to a database coupled to the Internet. Student knowledge gaps can thus be identified immediately and training created by the instructor on the fly.

The smart phone or wireless PDA aspect of the present disclosure described below provides the student with mobility between the classroom and laboratory where hands-on education takes place. Access to a large library of proprietary and subject-specific content may be invaluable in a hands-on learning environment. The ability for students to flag information “at the time” of learning for later review and customize their learning curriculum contributes to classroom efficiency and addresses specific student needs.

Students may use methods and systems disclosed herein in a classroom setting as a learning aid. Students may use a smart phone or PDA that is connected to a network to partake in assessments including, e.g., quizzes and tests, and as a blended learning-training aid by using the device as a resource for topics of discussion. Students may record notes using a computing device in a classroom and then review those notes using another computing device at a job site or home.

Instructors may use methods and systems disclosed herein in a classroom setting as an instructional aid. As examples, instructors may customize training modules to be delivered live in a classroom to create or modify content tailored for a specific class or adapt training modules over time to tailor to student needs (e.g., based on assessment results). The system may be implemented in a database-driven manner to enable instructors to adapt or customize training presentations.

An instructor may design and distribute assessment materials to students including, e.g., quizzes. A student's score in such assessments may be available to the instructor immediately upon completion of the assessment material by the student. The instructor may be able to review the student's results on the instructor's classroom terminal. As a result, the instructor may be able to assess knowledge gaps and review material as appropriate.

Users may log into the system via, for example, their handheld device, smart phone, or PDA with their user name and password. Alternatively, users may be authenticated by using biometric information including, e.g., fingerprints or voice, or by using a smartcard. Thereafter, the users can access on-line materials, such as educational materials in real time. Further, students can participate in quizzes and send quiz results to a server for tabulation and forwarding to an instructor. If a student scores poorly or has trouble understanding subject matter, the student can employ self-learning techniques included in the system. Students and instructors may also have the ability to create reminder lists of highlighted aspects of educational components they may want to brush up on. In addition, students can “bookmark” particular sections of the subject matter that are of particular interest to them. A student may bookmark, e.g., a document, quiz, feedback screen, or any other content that may be presented to the student.

Methods and systems disclosed herein may enable students to perform various learning-related activities after attending a classroom session. As examples, students may, e.g., view results of their assessments, review areas they have highlighted or bookmarked for review, review additional related material, collaborate with others about the information, and communicate with and evaluate instructors. Students may perform these activities from any location with Internet access, such as their home.

Under this embodiment, content that is provided in a classroom setting can also be provided to the student at a home computer (e.g., via an online learning web interface), or via a smart phone or wireless PDA. Furthermore, a product or instrument manufactured and/or sold by a manufacturer may have its own on-screen help instructions for access by users and operators. These instructions and other course materials may be configured to mimic the product or interface in such a way that an interface appears nearly identical online, on a product, or on a smart phone or PDA. Such uniformity in the instructional process can streamline and otherwise facilitate instruction in the use of products and instruments.

The invention will now be described with respect to various embodiments. The following description provides specific details for a thorough understanding of, and enabling description for, these embodiments of the invention. However, one skilled in the art will understand that the invention may be practiced without these details. In other instances, well-known structures and functions have not been shown or described in detail to avoid unnecessarily obscuring the description of the embodiments of the invention.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

Suitable Architecture

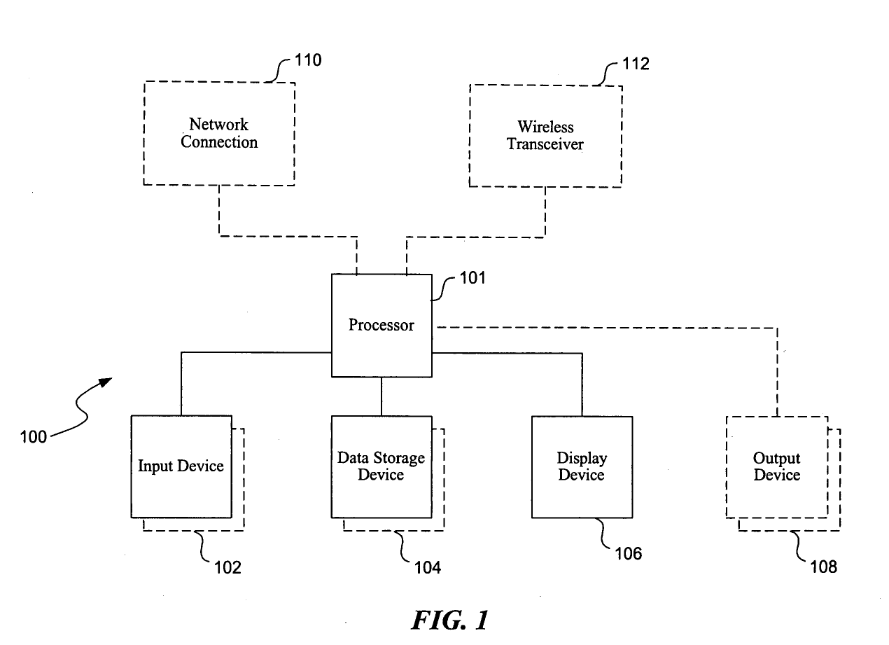

Turning now to the figures, FIG. 1 and the following discussion provide a brief, general description of a suitable computing environment in which aspects of the invention can be implemented. Although not required, aspects and embodiments of the invention will be described in the general context of computer-executable instructions, such as routines executed by a general-purpose computer (e.g., a server or personal computer). Those skilled in the relevant art will appreciate that the invention can be practiced with other computer system configurations, including Internet appliances, handheld devices, wearable computers, smart phones, cellular or mobile phones, multi-processor systems, microprocessor-based or programmable consumer electronics, set-top boxes, network PCs, mini-computers, mainframe computers, and the like. The invention can be embodied in a special purpose computer or data processor that is specifically programmed, configured, or constructed to perform one or more of the computer-executable instructions explained in detail below. Indeed, the term “computer,” as used generally herein, refers to any of the above devices, as well as any data processor.

The invention can also be practiced in distributed computing environments, where tasks or modules are performed by remote processing devices, that are linked through a communications network, such as a LAN, Wide Area Network (“WAN”), or the Internet. In a distributed computing environment, program modules or subroutines may be located in both local and remote memory storage devices. Aspects of the invention described below may be stored or distributed on computer-readable media, including magnetic and optically readable and removable computer discs, stored as firmware in chips (e.g., EEPROM chips or flash random access memory), as well as distributed electronically over the Internet or over other networks (including wireless networks). Those skilled in the relevant art will recognize that portions of the invention may reside on a server computer, while corresponding portions reside on a client computer. Data structures and transmissions of data particular to aspects of the invention are also encompassed within the scope of the invention.

Referring to FIG. 1, one embodiment of the invention employs a computer 100, such as a personal computer or workstation, having one or more processors 101 coupled to one or more user input devices 102 and data storage devices 104. The computer 100 is also coupled to at least one output device, such as a display device 106, and one or more optional additional output devices 108 (e.g., printer, plotter, speakers, tactile or olfactory output devices, etc.). The computer may be coupled to external computers, such as via an optional network connection 110 (e.g., modem, Ethernet card, etc.), a wireless transceiver 112 (e.g., infrared, Bluetooth, IEEE802.11, etc.), or both. The computer may be, e.g., a mainframe, personal computer, smart phone, PDA, palm-top computer, etc.

The input devices 102 may include a keyboard and/or a pointing device such as a mouse. Other input devices are possible, such as a microphone, joystick, pen, game pad, scanner, digital camera, video camera, and the like. The data storage devices 104 may include any type of computer-readable media that can store data accessible by the computer 100, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to a network such as a LAN, WAN, or the Internet (not shown in FIG. 1).

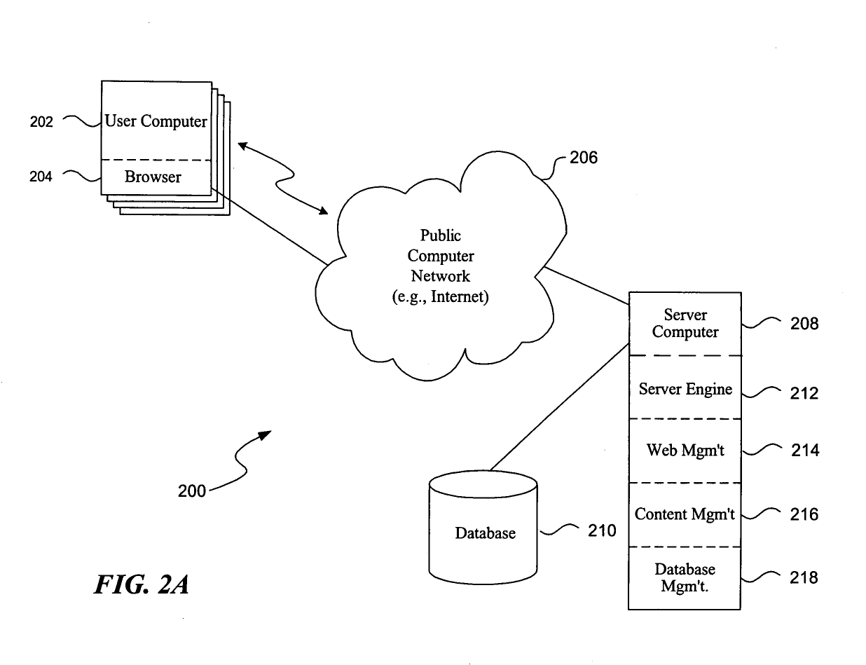

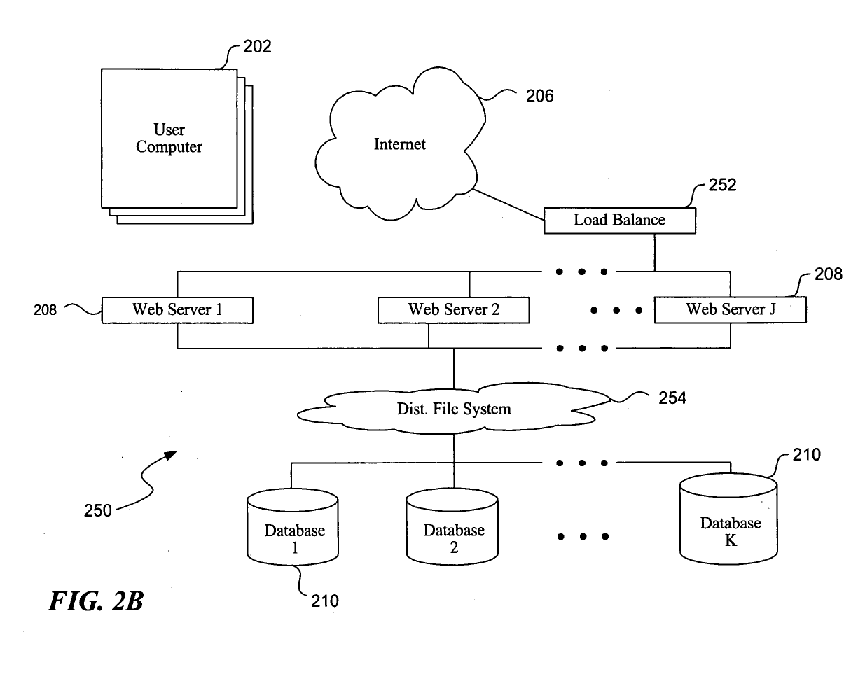

Aspects of the invention may be practiced in a variety of other computing environments. For example, referring to FIG. 2A, a distributed computing environment with a web interface includes one or more user computers 202 in a system 200 are shown, each of which includes a browser program module 204 that permits the computer to access and exchange data with the Internet 206, including web sites. The user computers may be similar to computer 100 of FIG. 1. User computers may include other program modules, such as an operating system, one or more application programs (e.g., word processing or spreadsheet applications), and the like. The computers may be general-purpose devices that can be programmed to run various types of applications, or they may be single-purpose devices optimized or limited to a particular function or class of functions.

At least one server computer 208, coupled to the Internet or Web 206, performs much or all of the functions for receiving, routing and storing of electronic messages, such as web pages, audio signals, and electronic images. While the Internet is shown, a private network, such as an intranet, may likewise be used. The network may have a client-server architecture, in which a computer is dedicated to serving other client computers, or it may have other architectures such as peer-to-peer, in which one or more computers serve simultaneously as servers and clients. A database 210 or databases, coupled to the server computer(s), stores much of the web pages and content exchanged between the user computers. The server computer(s), including the database(s), may employ security measures to inhibit malicious attacks on the system, and to preserve integrity of the messages and data stored therein (e.g., firewall systems, secure socket layers (“SSL”) password protection schemes, encryption, and the like).

The server computer 208 may include a server engine 212, a web page management component 214, a content management component 216, and a database management component 218. The server engine performs basic processing and operating system level tasks. The web page management component handles creation and display or routing of web pages. Users may access the server computer by means of a URL associated therewith. The content management component handles most of the functions in the embodiments described herein. The database management component includes storage and retrieval tasks with respect to the database, queries to the database, and storage of data such as training materials.

Referring to FIG. 2B, an alternative embodiment to the system 200 of FIG. 2A is shown as a system 250. The system 250 is substantially similar to the system 200, but may be used with numerous concurrent users. It includes more than one web server computer (shown as server computers 1, 2, . . . J). A web load balancing system 252 balances load on the several web server computers. Load balancing is a technique well-known in the art for distributing the processing load between two or more computers, to thereby more efficiently process instructions and route data. Such a load balancer can distribute message traffic, particularly during peak traffic times.

A distributed file system 254 couples the web servers to several databases (shown as databases 1, 2 . . . K). A distributed file system is a type of file system in which the file system itself manages and transparently locates pieces of information (e.g., content pages) from remote files or databases and distributed files across the network, such as a LAN. The distributed file system also manages read and write functions to the databases.

One skilled in the relevant art will appreciate that the concepts of the invention can be used in various environments in addition to the Internet. In general, a display description may be in HTML, XML, or WAP format, email format or any other format suitable for displaying information (including character/code-based formats, algorithm-based formats (e.g., vector generated), and bitmapped formats). Also, various communication channels, such as LANs, WANs, or point-to-point dial-up connections, may be used instead of the Internet. The system may be conducted within a single computer environment rather than a client/server environment. Also, the user computers may comprise any combination of hardware or software that interacts with the server computer, such as television-based systems and various other consumer products through which commercial or noncommercial transactions can be conducted. The various aspects of the invention described herein can generally be implemented in or for any computing environment.

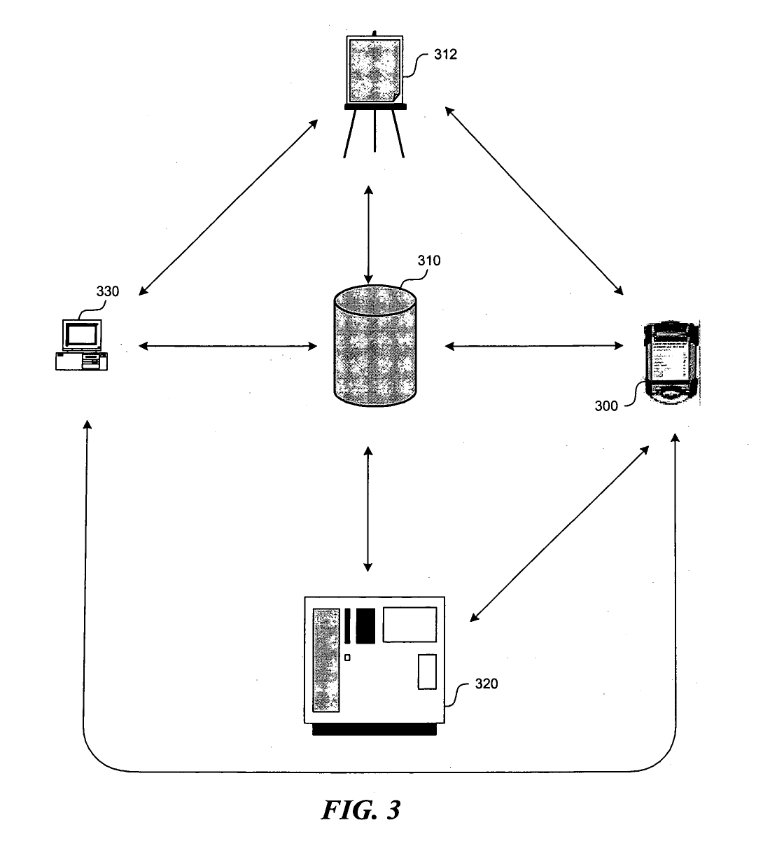

Referring to FIG. 3, an embodiment of the invention includes a handheld computer 300 that is similar to the computers described above and is usable by a student in a classroom setting to facilitate instruction from a teacher or other instructional entity 312. Unless described otherwise herein, the components depicted in FIG. 3 are well-known or described in detail in the above cross-referenced provisional patent application. Indeed, much of the detailed description provided herein is explicitly disclosed in the provisional patent application; much of the additional material of aspects of the invention will be recognized by those skilled in the relevant art as being inherent in the detailed description provided in such provisional patent application, or well known to those skilled in the relevant art. Those skilled in the relevant art can implement aspects of the invention based on the Figures and the detailed description provided in the provisional patent application.

Under this embodiment, the student can use the handheld computer 300 in a class setting to view his or her progress, view course outlines, take tests and other assessments, and bookmark areas to review at a later time. In addition, the student can use the handheld computer 300 to communicate with the instructor and keep course notes, provide course feedback, and collaborate with other students on coursework. The system may enable real-time feedback and collaboration.

Under this embodiment, a database 310 stores a variety of information. The database may store, e.g., information relating to the curricula, students, instructors, assessments, assessment results, bookmarks, user information, and notes. This information may be stored in a standard relational database or in XML form.

Under this embodiment, an instructor/facilitator 312, the student/participant using the computer 300 in a class or on-site setting, and a student/participant using a remote computer 330 in a remote (e.g., home) setting may communicate with the database 310 via a wired or wireless (e.g., a LAN) connection. The system allows the instructor 312 (using a suitable computer device) to view students' out of class work prior to class and provide updates to the course curriculum, as descried in greater detail below. In addition, the instructor 312 can electronically send exams to the students at remote locations and can receive student assessment information to assess students' progress.

The teacher 312 has access to a handheld computer, similar to the computer 300, and both the teacher's computer and the student computer 300 can be operably connected to the database 310 coupled to the Internet via, for example, a LAN. In an alternate embodiment, the database 310 is operably coupled directly to a LAN (not shown). In addition, the computer 300 is connected to other computer devices via a network connection, wireless transceiver, or both.

In the classroom, the student may use the computer 300 to, e.g., take notes, review course agendas prior to class, and take various course assessments during the class, thereby enabling the teacher to review the course assessments to optionally modify the course subject matter in real time based on the results of the student's assessments. Students may also use the computer 300 in the classroom to, e.g., view their progress, see the course outline, bookmark areas for further review, communicate with the instructor, provide feedback to the instructor, review responses from the instructor, collaborate with other students, and view results of their assessments. In addition, various portions of the curriculum can be personalized by the student and stored in a database coupled to the Internet, such as the database 310, for later access by the student.

The student may elect to access the Internet-based database 310 during hands-on training. Such access may be conducted from either the handheld computer 300 or a similar desktop device 320 in a laboratory setting. The student may also access the Internet-based database to obtain information regarding a particular product the student may be working on in the hands-on training session. The results of the student's hands-on training can be accessed by the teacher 312 for use in the classroom setting.

Under this embodiment, the database 310 includes a Learning Management System server that maintains student records, course materials, and other student-related, instructor-related, and course-related materials.

Under this embodiment, the student or other user can access the database to retrieve various portions of the instructional subject matter from the remote (e.g., home) computer 330. The remote computer 330 can include various general purpose computers, such as a laptop or desktop PC. The student may use the remote computer 330 in both pre-classroom and post-classroom work. Such pre-classroom work can include completing homework or other pre-class work, taking out-of-class tests and assessments, and viewing course outlines. In addition, such post-classroom work can include viewing class scores, reviewing areas bookmarked earlier, performing additional coursework, and collaborating with other students.

Access to the database 310 from the student's home outside of the classroom or laboratory setting can provide certain advantages as described above. For example, such access can enable the student to emphasize those areas of the instruction on which the student may need additional work. Such access can also enable the student to review material relating to an upcoming class or lab session. In addition, such access can enable the student to take assessments and other quizzes that can be provided to the teacher 312 to facilitate upcoming classroom sessions. The database 310 may be specifically adapted for a learning scenario or curriculum (including, e.g., field sales, medical professional, or field service). Alternatively, the database may be generalized across learning scenarios and curricula.

Those of ordinary skill in the relevant art will appreciate that FIG. 3 and the associated discussion describes but a few possible embodiments of methods and systems in accordance with the invention. Accordingly, in other embodiments, the smart phone, PDA, or handheld computer 300 can be used in concert with the database 310 to provide yet additional advantages and features in an educational environment.

Suitable Functionalities

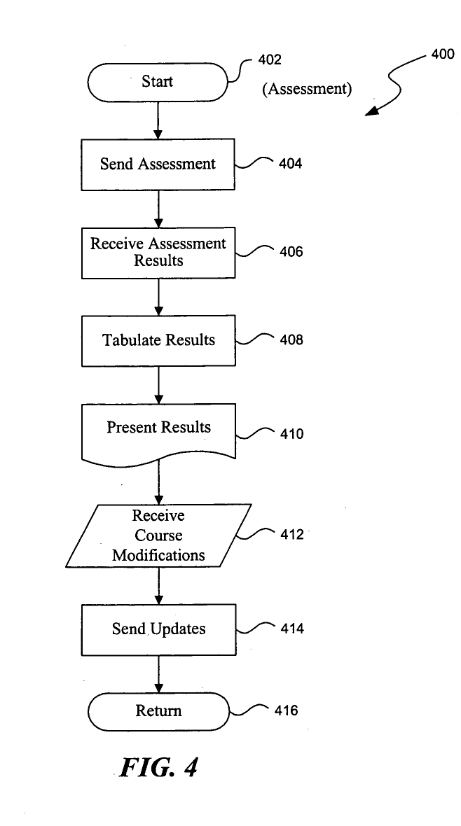

FIG. 4 is a flow diagram illustrating a suitable routine for modifying course content in response to an assessment. The routine 400 and others described below can be implemented with the networked computer system described above in relation to FIG. 3. These flow diagrams do not show all functions or exchanges of data, but instead provide an understanding of commands and data exchanged under the system. Those skilled in the relevant art will recognize that some functions or exchange of commands and data may be repeated, varied, omitted, or supplemented, and other (less important) aspects not shown may be readily implemented.

The routine 400 begins at block 402 where it receives an indication of an assessment as a parameter. An assessment can be, e.g., a quiz or other inquiry designed to assess a student's grasp of a subject relating to the material being taught. At block 404, the routine sends the assessment to connected student computers, or otherwise makes the assessment available to the student computers. The assessment may be sent using a network connection such as, e.g., a wireless or wired network. At block 406, the routine receives results relating to the assessment sent at block 404. As an example, the routine may receive indications relating to answers given by students to the quiz provided at block 404. The routine may receive or retrieve the results in a manner similar to how an assessment was sent at block 404.

At block 408, the routine tabulates the results received at block 406. As an example, the routine may determine whether answers to questions provided by students are correct. At block 410, the routine presents the results to an instructor. The instructor may be able to review areas of knowledge gaps for a student or for an entire class. The results may be presented on a display device connected to the instructor's computer. The routine may also present suggested modifications to course modules. At block 412, the routine receives indications of modifications to course materials from the instructor. As an example, the instructor may choose to accept modifications to the material suggested by the routine at block 410. Alternatively, the routine may accept specific modifications indicated by the instructor. At block 414, the routine sends the modifications indicated at block 412 as updates to course materials. These updates may be sent to students' computers. The routine returns to its caller at block 416.

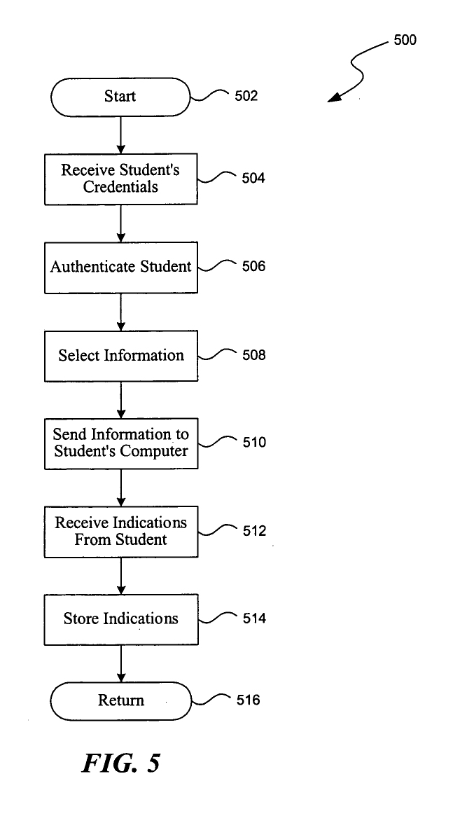

FIG. 5 is a flow diagram illustrating a suitable routine for storing indications from a user relating to content of a course. The routine begins at block 502. At block 504, the routine receives a student's credentials. Examples of a student's credentials include, e.g., an indication of a user name and password, or any other indication of credentials accepted by an operating system of the computer system performing the routine. At block 506, the routine may authenticate the student's credentials. At block 508, the routine selects information relating to the student. As an example, the routine may determine that the student is attending a class. The routine may then select course materials relating to the class. The selection may include time-specific information. As an example, the routine may select a set of material for a first day of the class and a different set of material for a second day of the class.

At block 510, the routine sends the information selected at block 508 to the student's computer. At block 512, the routine receives indications relating to the content from the student. As an example, the routine may receive an indication that the student wishes to bookmark some content. As another example, the routine may receive an indication that a student is unclear about some content. At block 514, the routine stores these indications. As an example, the routine may store these indications in the database 310. At block 516, the routine returns to its caller.

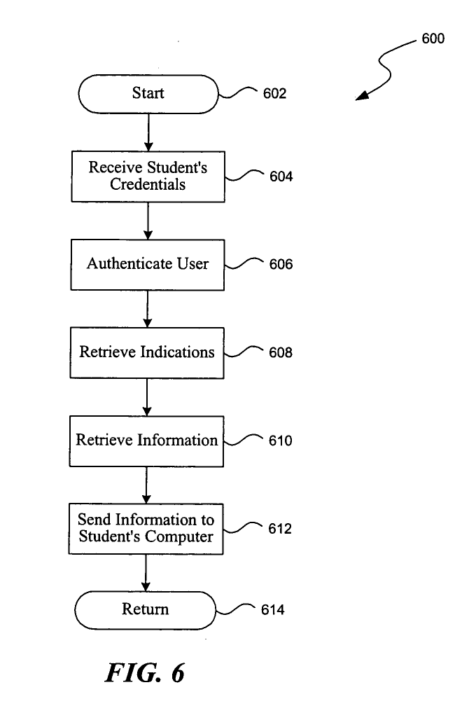

FIG. 6 is a flow diagram illustrating a suitable routine for sending course content to a student's computer. At blocks 602 to 606, the routine receives and authenticates a student's credentials. At block 608, the routine may retrieve indications provided by the student at block 512 of FIG. 5. As an example, the routine may retrieve indications of bookmarks. At block 610, the routine retrieves information relating to the indications retrieved at block 608. As an example, the routine may retrieve information relating to the content bookmarked earlier by the student from the database 310. At block 612, the routine sends the information to the student's computer. The routine returns to its caller at block 614.

The student may use a different computer to retrieve information bookmarked earlier than a computer used to indicate the bookmarks. As an example, the student may indicate bookmarks while in a class using a classroom computer and may subsequently retrieve the bookmarked information at home using a home computer.

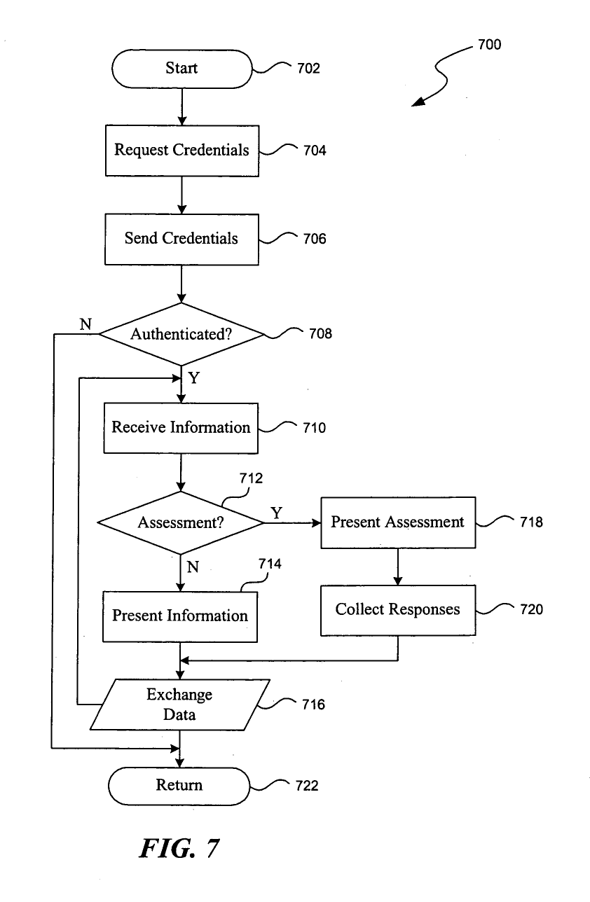

FIG. 7 is a flow diagram illustrating a suitable routine performed by a student's computer in a classroom setting. At blocks 702 to 708, the routine 700 receives and authenticates a student's credentials. If the student is authenticated, the routine continues at block 710. Otherwise, the routine continues at block 722 where it returns to its caller.

At block 710, the routine receives information from the server. As an example, the routine may receive indications of content to be displayed. As another example, the routine may receive an indication that an assessment is to be made of the student. At block 712, the routine determines whether an assessment is to be made. If so, the routine continues at block 718. Otherwise, the routine continues at block 714.

At block 714, the routine presents information received at block 710. As an example, the routine may present course content. As a further example, the instructor may present customized content for the student. At block 716, the routine exchanges data with the server. As an example, a student may indicate that an educational component was not clearly understood. After the server receives this information, the server may send the routine an indication that it is to receive and present additional information. In such a case, the routine may continue at block 710. If the routine receives an indication from the server that the class has ended, for example, the routine continues at block 722.

At block 718, the routine presents the assessment received at block 710. As an example, the routine may present a sequence of questions relating to a quiz it has received. At block 720, the routine collects responses to the assessment. As an example, the routine may collect answers to the questions of the quiz. The routine then continues at block 716 where it may send the responses collected at block 720 to the server.

The routine may receive both questions and answers relating to the assessment at block 710. In such a case, the routine may determine which questions were answered correctly and send this information to the server at block 716. Alternatively, the routine may only receive an indication of questions and information relating to the questions at block 710. In such a case, the routine may collect the student's answers at block 720 and send them to the server at block 716. The routine may then present an outcome of the assessment to the student. At block 722, the routine returns to its caller.

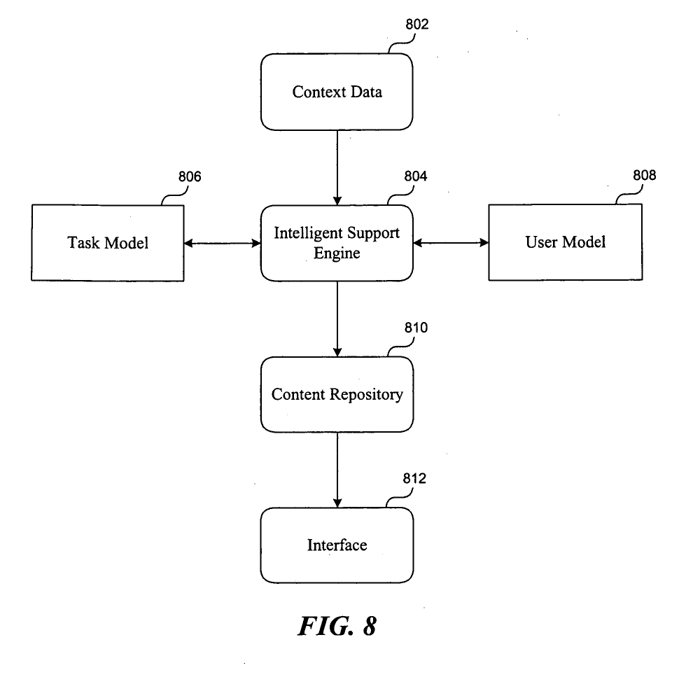

FIG. 8 is a block diagram illustrating an example of an object framework for delivering course content to a student. The framework has context data 802 relating to a context of the class or situation a student or instructor is in. As an example, a student may be retrieving course content from a remote (e.g., home) computer. Alternatively, the student may be viewing the content on a smart phone or PDA while in the classroom. The framework may recognize that a student is using a type of computing device by “sniffing” it. Alternatively, the device may provide an indication to the framework. An intelligent support engine 804 retrieves this context data, a task model 806, and a user model 808 to generate content. The task model 806 includes information relating to a task a user is to perform. Examples of tasks may include, e.g., reviewing material, requesting detailed material, or responding to an assessment. A user model 808 includes information relating to how a user (e.g., a student or instructor) will interact with the system. As examples, a student may wish to respond to an assessment using multiple-choice questions. The content generated by the engine 804 may be stored in a content repository 810. This repository may be the database 310 or an alternative database (not shown). Data from the repository may be retrieved and presented in an interface 812 to the user. This data may be in XML form or other form suitable for presentation, perhaps through some transformation. Using this object framework, the system is thus able to present appropriate information for the user. In an embodiment, the intelligent support engine generates content for a variety of contexts, task models, and user models for storing in the content repository 810 before a class begins.

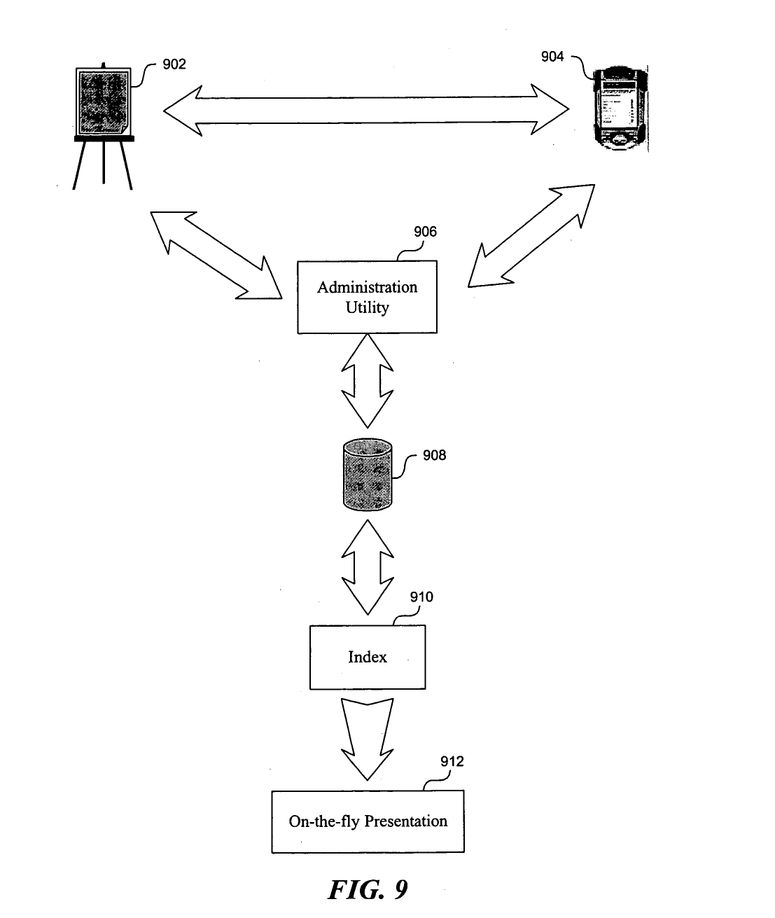

FIG. 9 is a block diagram illustrating an example of an administrative interface for the system. An administration utility 906 is used by an instructor to, e.g., create or modify an agenda, customize pre-class study material, customize material for use in a classroom, create quizzes or other assessments, create customized topics for use by a class, and create post-class study material. These materials and modifications may be available to students in real time. This information may be presented through an instructor's presentation device 902 or on a student's smart phone or PDA, 904. Material entered or made available on an instructor's presentation device or student's smart phone or PDA may also be made available on the other. The administration utility 906 may store data in and retrieve data from a database 908. This database may be the database 310. The database may be indexed in an index 910 for quickly creating an “on-the-fly” presentation 912. An instructor may, e.g., generate content “on-the-fly” to clarify subject matter during class.

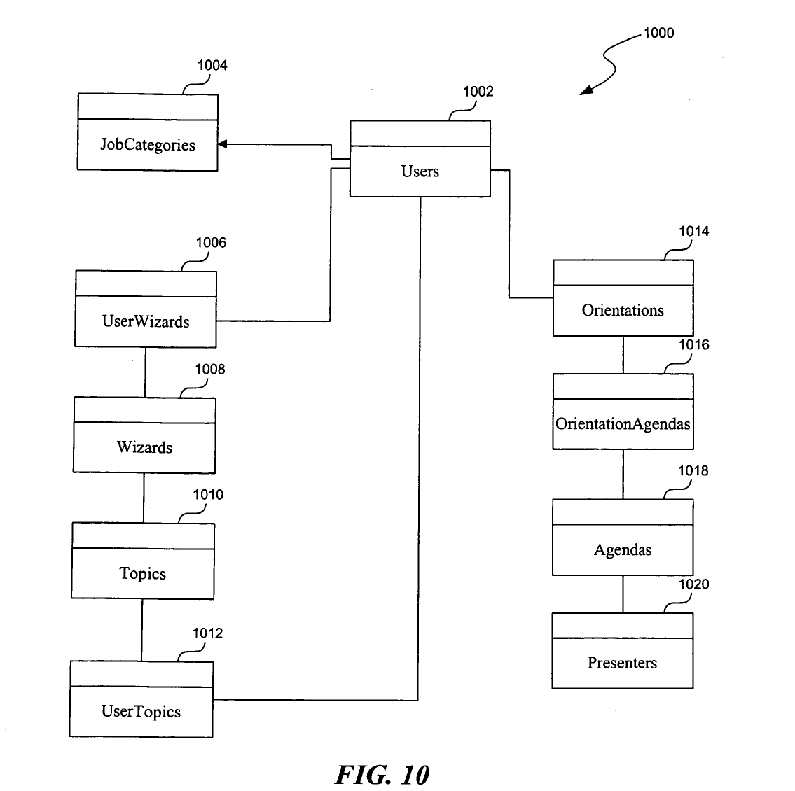

FIG. 10 is a block diagram illustrating an example of a database schema for use with the system. Under this embodiment, a database comprising the illustrated schema 1000 is stored in the database 310. The illustrated schema may be used to train new employees of an organization. The schema has several tables including Users 1002, JobCategories 1004, UserWizards 1006, Wizards 1008, Topics 1010, UserTopics 1012, Orientations 1014, OrientationAgendas, 1016, Agendas 1018, and Presenters 1020. These tables have database relationships. The Users table 1002 is related to the JobCategories 1004, UserWizards 1006, UserTopics 1012, and Orientations 1014 tables. The relationships are based on keyed unique identifier (“ID”) columns of the tables. As examples, the Users 1002 table has UserID, JobCategoryID, and OrientationID columns (not shown). Similarly, the JobCategories 1004 table has a JobCategoryID column, the UserWizards 1006 table has UserID and WizardID columns, the Wizards 1008 table has a WizardID column, and the Orientations 1014 table has an OrientationID column (not shown).

The Users table 1002 comprises information relating to users. Such information may include, e.g., name, contact information, organizational position, and job category. The Users table may also have relationships with tables other than those shown in the figure to, e.g., store information relating to bookmarks the user has stored, assessments the student has undertaken, and results from the assessments. The table may also store information used to authenticate users.

The JobCategories table 1004 comprises information relating to job categories of people in the organization. As examples, there may be managers, engineers, and salespersons. By associating a user with a job category, the system identifies which job category the user performs.

The UserWizards table 1006 comprises indications of wizards relating to a curriculum identified for a user. A wizard is a sequence of instructional or educational material. As an example, the organization may require managers to go through a set of wizards and engineers to go through another set. Some wizards may be common to both sets.

The Wizards table 1008 comprises names for wizards, indications for sequences of instructional or educational material, indications for locations of the material (e.g., URLs or other links), and indications for locations of additional related material. The Wizards table 1008 may also include indications of assessments to be provided to a user, e.g., upon completion of a wizard.

The Topics table 1010 comprises topics and relating information for instruction. A wizard may have several topics relating to the wizard. The Topics table additionally comprises indications for locations of the information (e.g., URLs or other links) and indications of assessments relating to topics.

The UserTopics table 1012 comprises indications of topics relating to users. As an example, a set of several topics may be indicated for a user based on the user's job category.

The Orientations table 1014 comprises information relating to orientation classes. As an example, the table may store indications of when an orientation class is scheduled and a description of the material that may be taught at the orientation class.

The OrientationAgendas 1016 table comprises indications of agendas of orientation classes stored in the Orientations table 1014.

The Agendas table 1018 comprises information relating to an agenda of an orientation class. As examples, the Agendas table may store indications of presenters or instructors for a class, titles of agendas, description of educational material, and durations of classes.

The Presenters table 1020 comprises information relating to presenters or instructors. This information may include, e.g., name, contact information, and notes.

A skilled artisan would recognize that this schema can be extended to cover other information described above but not illustrated in this example or figure.

Other Suitable Functionalities

In an embodiment, a student or students log into a handheld device or devices in a classroom or laboratory setting as part of an instructional program. For example, an instructional program may be used to educate employees or other personnel about a particular piece of equipment the employees will be operating. The handheld device may display instructional information to the student. The student may then bookmark selected portions of the information to use “on the job.”

An example of a training or performance support scenario employing the above embodiments may be as follows. A student initially goes to a particular web site to obtain some on-line learning. The on-line learning provided at this web site would provide some basic information to the student. Thereafter, the student enters formal classroom training, hands-on training, or both. During this training period, the student receives a wireless or portable computer. The portable computer may provide a real-time link to a database running on a server that includes much of the content to be provided on the portable computer.

The content stored on the database associated with the server computer may be configured for use by a variety of computers including, e.g., smart phone or PDAs. For example, a server may dynamically resize pages of information and graphics to adapt these media forms for a variety of displays. Likewise, navigation between pages may be optimized for use on such portable computers; such as by providing appropriate links on a given displayable page for the user. The portable computer may include not only a browser application, but may also include a multimedia player to play back video, audio, or both.

During classroom hands-on training, the teacher may request that a student access a particular link via the portable computer to view, for example, a video of operation of the device. For example, the video may display how a given instrument may jam, be maintained, and the like. The teacher may provide content to students on the portable computer. For example, if the teacher has several slides of information to present (such as via a presentation graphics application program), the teacher may provide these slides to the students via portable computers. In particular, the slides may be provided by the server computer from the database for display on a portable computer.

After providing instruction, the instructor may provide an assessment to test a student. The student may then perform the test and return a response to the instructor via the wireless link.

If the student does not understand a particular aspect of the training, he or she may attach a bookmark to the particular subject being taught at that time. Thereafter, the student may log into a web site relating to the training to obtain more information regarding the bookmarked topic areas. When the user bookmarks a particular subject for later review, the portable computer may send an indication to the server computer. When the student later logs in at the web site, the web site may provide a list of the bookmarked material to the student, so that the student may readily access the particular subject areas on which the student wishes to receive more information.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words in the above Detailed Description using the singular or plural number may also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

The above-detailed descriptions of embodiments of the invention are not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or steps are presented in a given order, alternative embodiments may perform routines having steps in a different order, and some steps may be deleted, moved, added, subdivided, combined, and/or modified. Each of these steps may be implemented in a variety of different ways. Also, while these steps are shown as being performed in series, these steps may instead be performed in parallel or may be performed at different times.

The teachings of the invention provided herein can be applied to other systems, not necessarily the system described herein. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description details certain embodiments of the invention and describes the best mode contemplated, no matter how detailed the above appears in text, the invention can be practiced in many ways. Details of the learning system may vary considerably in its implementation details, while still be encompassed by the invention disclosed herein. As noted above, particular terminology used when describing certain features or aspects of the invention should not be taken to imply that the terminology is being re-defined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

1. A method performed by a computer system for exchanging educational material in an adult, corporate learning environment, the method comprising:
sending educational content to multiple, portable student computing devices from a central database associated with a server computing device, wherein the educational content is associated with at least a portion of a particular subject to be learned by multiple adult students in the corporate learning environment;
substantially concurrently and wirelessly sending an assessment or quiz relating to the educational content to the multiple portable student computing devices during an educational lesson;
wirelessly receiving results relating to the assessment or quiz from the multiple portable student computing devices during the educational lesson;
tabulating or aggregating the received results during the educational lesson, wherein the tabulated or aggregated results reflect how well the multiple adult students understood the educational content;
providing to a portable teacher computer the tabulated or aggregated results reflecting how well the multiple adult students understood the educational content during the educational lesson, and
when the tabulated or aggregated results indicate that at least some of the multiple adult students have not understood at least portions of the educational content, then
sending supplemental content complementing the educational content to the multiple portable student computing devices from the central database, wherein the supplemental component relates to and reinforces at least portions of the educational content.

2. The method of claim 1 wherein the portable student computing devices include portable digital assistants having short-range wireless communication transceiver or Internet-ready cellular telephones.

3. The method of claim 1 wherein sending educational content is performed wirelessly.

4. The method of claim 1 wherein providing to a portable teacher computer the tabulated or aggregated results is performed wirelessly.

5. The method of claim 1 wherein sending supplemental content is performed wirelessly.

6. The method of claim 1, further comprising receiving a request from one of the portable student computers for additional content related to an aspect of the educational content, and wirelessly providing the additional content to the one portable student computer.

7. The method of claim 1 wherein the educational lesson is performed substantially concurrently among remote adult students in multiple geographically distinct locations.

8. The method of claim 1, further comprising providing teacher tools to assist the teacher in creating an agenda for the educational lesson, creating study materials for use by the adult students before the educational lesson, and creating educational materials for use during the educational lesson.

9. The method of claim 1 wherein the supplemental content is determined by evaluating context data related to the educational lesson, a task model relating to a task that the adult students are to perform related to the educational content and the educational lesson, and a user model relating to how individual adult students interact with the computer system.

10. A method performed by a computer system for exchanging educational material, the method comprising:
identifying a student operating a first portable computing device;
selecting information relating to an educational component to send to the first portable computing device;
adapting the selected information for presentation on the first portable computing device based on a size of a visual display device associated with the first portable computing device;
wirelessly sending the adapted information to the first portable computing device;
receiving an indication from the student relating to the sent information;
storing the indication; and
when the identified student operates a second computing device,
identifying information relating to the educational component based on the stored indication;
adapting the identified information for presentation on the second computing device; and
sending the identified information to the second computing device.

11. The method of claim 10 wherein the wirelessly sending includes wirelessly and concurrently sending the adapted information to multiple portable computing devices during an educational lesson related to the educational component.

12. The method of claim 10 wherein the selecting includes identifying a context, a task model, and a user model.

13. The method of claim 10 wherein adapting the selected information for presentation on the first portable computing device includes considering a rendering capability of the first portable computing device.

14. The method of claim 10 further comprising receiving from the first computing device notes from the identified student, and storing the notes in a portion of the central database associated with the identified student.

15. The method of claim 10 wherein the indication from the identified student is a bookmark.

16. The method of claim 10 wherein the indication from the identified student is a question relating to the educational component.

17. The method of claim 10 wherein the indication is stored in a central database.

18. The method of claim 17 wherein an indication stored in the central database is available from a computer coupled to the Internet.

19. The method of claim 10 wherein the identifying includes authenticating the identified student.

20. A system for enabling mobile learning over at least one computer network, the system comprising:
a server computing device and associated central database for storing an educational component and a complementary educational component, wherein the server includes a web-based front end for providing access to the stored educational component and complementary educational component;
a first mobile student computing device for presenting the educational component to a student and indicating an aspect of the educational component, the indication subsequently being stored on the server computing device; and
a second student computing device for presenting the complementary educational component based on the stored indication to the student, wherein the server, first, and second computing devices are configured to exchange information via the at least one network.

21. The method of claim 20 wherein the educational component includes material for presentation by an instructor during class.

22. The method of claim 20 wherein the complementary educational component is a quiz.

23. The method of claim 20 wherein the complementary educational component is additional material relating to the educational component.

24. The method of claim 20 wherein the indication is a bookmark.

25. The method of claim 20 wherein the indication is an area a student wishes to review after class.

26. A system for enabling mobile learning, the system comprising:
means for identifying a user operating a mobile computing device, the identifying including authenticating credentials supplied by the user;
means, coupled to the means for identifying, for receiving information from an instructional computing device, wherein the received information relates to an educational component;
means, coupled to the means for receiving, for presenting the received information on the mobile computing device; and
means, coupled to the means for presenting, for determining whether the received information indicates that an assessment is to be performed, and when an assessment is indicated,
presenting the assessment;
collecting a response to the assessment; and
sending the response to the instructional computing device.

27. The system of claim 26 including means for exchanging data with the instructional computing device.

28. The system of claim 27 wherein when data is received from the instructional computing device indicating that the received information relating to the educational component is to be modified, and wherein receiving information includes receiving modifications to the educational component.

29. The system of claim 28 wherein the indication to modify the educational component includes a real-time modification to the instructional component by an instructor.

30. A computer-readable medium containing a data structure, the data structure comprising:
an educational component, wherein the educational component is created by an intelligent support engine that takes into consideration context data, a task model, and a user model;
a question relating to the educational component, wherein the question is designed to determine whether a student has understood the educational component; and
an answer to the question.

31. The computer-readable medium of claim 30 wherein the educational component includes streaming media.

32. The computer-readable medium of claim 30 including indications for proper presentation of the educational component.

33. The computer-readable medium of claim 30 including indications for proper presentation of the educational component, wherein the indications are represented in XML.

34. The computer-readable medium of claim 30 wherein the computer-readable medium is a memory of the telecommunications mobile device.

35. The computer-readable medium of claim 30 wherein the computer-readable medium is a logical node in a computer network receiving the educational components.

36. The computer-readable medium of claim 30 wherein the computer-readable medium is a computer-readable disk.

37. The computer-readable medium of claim 30 wherein the computer-readable medium is a data transmission medium carrying a generated data signal containing the educational components.

38. The computer-readable medium of claim 30 wherein the computer-readable medium is a memory of a computer system.
